(19) United States
(12) Patent Application Publication
(10) Pub. No.: US 2003/0046587 A1
(43) Pub. Date: Mar. 6, 2003

(54) Secure remote access using enterprise peer networks

(76) Inventors: Satyam Bheemarasetti, Edison, NJ (US); Chandra Prathuri, Piscataway, NJ (US)

Correspondence Address: GOTTLIEB RACKMAN & REISMAN PC, 270 MADISON AVENUE, 8TH FLOOR, NEW YORK, NY, 100160601

(21) Appl. No.: 10/189,349

(22) Filed: Jul. 3, 2002

Related U.S. Application Data
(60) Provisional application No. 60/317,157, filed on Sep. 5, 2001.
(60) Provisional application No. 60/352,602, filed on Jan. 29, 2002.

(51) Int. Cl. H04L 9/00

(52) U.S. Cl. 713/201

(57) ABSTRACT

A system for accessing data from any location and any device including those behind firewalls, proxy servers, address translations and other devices, while securing the data and network. The system employs a secure peer network between data sources regardless of their location enabling data access devices to retrieve or submit data from any Internet enabled device from any location. Messages are tunneled to HTML that passes through firewalls. A Queue Manager in the EPN Server software creates a unique queue for data source which can only be accessed by the data source. The user with a browser enabled device can then access the EPN Server by providing the necessary credentials, such as user id and password, and can then access the data in the data sources for which the user is permissioned. The data source maintains a non-persistent connection through a polling algorithm and services the request in the queue.

### FIELD OF THE INVENTION

This invention relates to systems mediated by a third party for enabling users or permitted programs to access data from web enabled devices securely without making any modifications to the networks or systems on which the data resides.

### BACKGROUND OF THE INVENTION

The present invention is best understood in contrast with prior art virtual private networks termed VPNs. VPNs use publicly-accessible infrastructure, such as the Internet or the public telephone network, as a substitute for dedicated secured private communication lines in creating a private network connection. Since a portion of the VPN must be accessible to the public, the VPNs typically employ some combination of encryption, digital certificates, strong user authentication and access control to provide security to the traffic they carry, so that the information being carried and access to the private components of the VPN is not available to the general public who may have access to the publicly-accessible infrastructure portion of the VPN.

VPNs may exist between an individual machine and a private network (client-to-server) or a remote LAN and a private network (server-to-server). Security features include mechanisms for hiding or masking information about the private network topology from potential attackers on the public network.

There are many prior art VPN products, which all seem to fall into three broad categories: hardware-based systems, firewall-based VPNs and standalone VPN application packages. Most hardware-based VPN systems are encrypting routers. They provide the highest network throughput of all VPN systems, since they don't require processor overhead in running an operating system or other applications. Some hardware VPN packages offer software-only clients for remote installation, and incorporate some of the access control features more traditionally managed by firewalls or other perimeter security devices.

Firewall-based VPNs expressly rely upon the firewall's security mechanisms. Several modify the host operating system kernel by stripping out dangerous or unnecessary services, providing additional security for the VPN server. Performance of these systems is degraded if the firewall is already loaded and this has forced some firewall vendors to offer hardware-based encryption processors to minimize the impact of VPN management on the system.

Software-based VPNs are used where both endpoints of the VPN are not controlled by the same organization (typical for client support requirements or business partnerships), or when different firewalls and routers are implemented within the same organization. Many software-based products allow traffic to be tunneled based on address or protocol, unlike hardware-based products, which generally tunnel all traffic they handle, regardless of protocol. Tunneling is a technology that enables one network to send its data via another network's connections. Tunneling works by encapsulating a network protocol in packets carried by the second network. For example, Microsoft technology enables organizations to use the Internet to transmit data across a VPN by embedding its own network protocol within the TCP/IP packets carried by the Internet. These software-based systems are generally harder to manage than encrypting routers. They require familiarity with the host operating system, the application itself, and appropriate security mechanisms. And some software VPN packages require changes to routing tables and network addressing schemes.

The problem with all of the foregoing schemes is that they require complex components to deal with the security issues raised by attempting to fully implement access to all the features of the accessed network that would be available to a non-virtual dedicated line connection between the user and the private network or data source host. Opening up a protected host to a virtual network gives rise to the technical and security problems that make VPN's expensive, complicated, difficult to administer and difficult to secure.

Remote access solutions are offered by traditional VPN vendors (Cisco, Nortel, Nokia), vendors of software based VPNs (Checkpoint) and VPN managed service providers (eTunnels, SmartPipes with WorldCom). Centralized web storage such as Xdrive and Visto also claim to offer remote access facility. The traditional VPN providers, once authenticated, make the user's remote device a part of the corporate network without being able to set up granular access controls. (Granular access controls refer to the ability to limit access to narrowly defined assets available to the user such as individual directories or individual files.) This leads to highly restrictive remote access solutions over VPN. Also the solutions are complex and very expensive to set up and manage.

There have also been disclosures of access to specific secured assets without implementing a full VPN. U.S. Pat. No. 6,081,900 to Novell entitled “Secure Intranet Access” described a system in which a remote client accesses all web pages on a target server within a secure network. A secure network is provided with the help of authentication software to allow direct access by a user to the target server only after the user is authenticated by the user's authentication system. Then the user has access to web pages on the target server delivered after conversion by a URL transformer termed an “SSL-izer”. The URL transformer replaces instances of “http” that refer to locations inside the secure network with corresponding instances of “https” that refer to the same location. The URL transformer is located on the target server or a border server that is within the same firewall as the target server. SSL is short for Secure Sockets Layer, a protocol developed by Netscape for transmitting private documents via the Internet. SSL works by using a public key to encrypt data that's transferred over the SSL connection. Both Netscape Navigator and Internet Explorer support SSL, and many Web sites use the protocol to obtain confidential user information, such as credit card numbers. By convention, Web pages that require an SSL connection start with https: instead of http:.

U.S. patent application 2001/0009025 published Jul. 19, 2001, is entitled “Virtual Private Networks”. This discloses a traditional VPN using IPSEC (IP Security Protocol) based communication. A special client is required on an access device that communicates over IPSEC, including authentication using Security Association (SA) certificates, via a Secure Gateway.

European Patent application 1 081 918 of Hewlett-Packard Company, published Mar. 7, 2001, is entitled “Providing Secure Access Through Network Firewalls”. Here a program inside a firewall communicates with outside web service through the firewall and receives responses. An applet, downloaded via a browser, on an inside computer, opens a socket connection (inside-out is allowed) with outside web service and communicates using HTTP GET messages (Sockets on top of HTTP). Outgoing messages and incoming HTTP responses are allowed by the firewall. After a predetermined interval, to provide some security, the communication socket is closed irrespective of whether access between the service and the client is required to continue; the process is repeated if access between the service and the client is required to continue.

U.S. Pat. No. 6,061,797 to IBM issued May 9, 2000, entitled “Outside access to computer resources through a firewall”. This employs firewalls to screen outside-in traffic. The patent discloses two servers, A (inside) and B (outside), on both sides of a firewall, and maintains ‘controlled connections’ using a list of ‘trusted sockets’. The list of trusted sockets is created and maintained exclusively by the inside tunneling application and communicated to the outside server. Outside clients communicate via B->A->internal machines. For each data connection, A and B spawn child processes A.1 and B.1 that communicate.

U.S. Pat. No. 5,960,404 to IBM issued Sep. 28, 1999, entitled “Mechanism for heterogeneous, peer-to-peer, and disconnected workflow operation”. This patent uses queue based disconnected processing for workflow. It is not, however, concerned with remote access between heterogeneous peers. This patent discloses peer-to-peer workflow execution across a network. Performer Agents and Source Agents are continuously available although the Sources may disconnect from the Source agents and Performers may disconnect from Performer agents.

U.S. Pat. No. 6,055,575 to Ascend Communications, Inc. issued Apr. 25, 2000, entitled “Virtual Private Network System and Method”. This patent allowed remote users to access a private network via a public network having a different communications protocol so that the remote user appears to be connected directly to the private network and appears to be a node on that private network. It requires a host software application on the private network to provide a communications path for secure access of the remote client computer.

U.S. patent application publication of Netilla Networks, Inc., 2001/0047406 was published Nov. 29, 2001, based on an application filed Apr. 13, 2001, entitled “Apparatus and Accompanying Methods for Providing Through a Centralized Server Site, an Integrated Virtual Office Environment, Remotely Accessible Via a Network-Connected Web Browser, with Remote Network Monitoring and Management Capabilities.” This application discloses a virtual office user environment through which a remotely stationed user can access typical office network-based applications including file sharing through a WAN connected web browser. It employs a service enablement platform (SEP) connected to both the WAN and a LAN and acting as a bridge between them. The SEP is required to translate user input originating from the browser into application-specific protocols and to apply a result to a corresponding office application server.

U.S. Pat. No. 6,158,011 to V-One Corporation, issued Dec. 5, 2000, entitled “Multi-Access Virtual Private Network”. It discloses a VPN using applications level encryption and mutual authentication and a shim at the client computer to intercept function calls, requests for service or data packets. It authenticates the parties to a communication and enables them to communicate to establish a common session key. Where the parties to the communication are peer-to-peer applications, they are authenticated and via encryption are enabled for direct peer-to-peer communication.

U.S. Pat. No. 5,991,810 to Novell, Inc., issued Nov. 23, 1999, entitled “User Name Authentication for Gateway Clients Accessing a Proxy Cache Server”. This patent discloses a system for regulating access to a proxy cache server including a directory for storing user names. The proxy cache server reads requests and, if stored control guidelines are met, retrieves and delivers requested site information to clients.

U.S. Pat. No. 5,768,271 to Alcatel Data Networks, Inc., issued Jun. 16, 1998, entitled “Virtual Private Network”. This discloses a VPN including selected portions of a packet-based network's resources. The patent is concerned with avoiding congestion on the VPN such that congestion outside of the VPN's logical domain does not affect the performance of the VPN. There are virtual paths established and multiplexed over a physical path such that each virtual path is assured a guaranteed bandwidth.

### BRIEF DESCRIPTION OF THE INVENTION

The present invention provides apparatus for transferring files between an in house Data Source (any desktop or file server that hosts user data) and a user anywhere on the Internet. The file transfer is mediated by an EPN Server. (EPN stands for Enterprise Peer Network.) The invention solves the problem of maintaining the security of the EPN Server's files while allowing access to remote users who are authorized to access and retrieve the files. This is accomplished without compromising the security of the Data Source. In particular it does not require the Data Source to modify its firewall or other security to allow the user to enter as a special user.

The way the system operates is to have the Data Source register with an EPN Server (central to all communication) that can access its files over the Internet using conventional Internet security. It is then the responsibility of the EPN Server to determine the user's credentials and again, using conventional Internet security, transfer the file to the user. The EPN Server does not store the Data Source files. Instead it maintains a request queue in which it stores the file requests desired by the user. The Data Source having the files periodically polls the queue to determine which files to upload to the EPN Server.

In order for the user to know which files are available the EPN Server also obtains from the Data Source information about the available files. This information is displayed to the user as a tree structured directory making the files appear to be another available directory tree as if mapped to the computer drives available to the user. The Data Source has complete control over the directories or files that may be listed in this manner. Thus the user sees only those directories or files that the Data Source deems appropriate to be available for transferring to the user.

In use the system operates as follows: The user accesses the directory tree listing the files that are available for downloading and selects the particular files that it desires. It then makes the downloading request. This request is transmitted over the Internet to the EPN Server, which confirms the user's identity and places this request in a request queue. The Data Source polls the request queue and retrieves the request. The Data Source then transits the requested file to the EPN Server and ends its connection. The intermittent nature of the communication between the Data Source and the EPN Server is an important component of security of the system, since for the majority of time there is no connection to be hacked and violated.

In addition to responding to specific user requests, the system also allows for the periodic downloading of predetermined files or file groupings. This is accomplished by substituting for the user's queue listing a stored command that periodically instructs the queue to request files from the Data Source. From that point forward the system operates in the same manner as if there were individual requests from a user. This embodiment would, for example, be useful in a system where a remote user requires a periodic update of a database such as an inventory.

An important characteristic of the invention is that the user never communicates directly with the data source, but all communication goes through a resident application on an EPN server. The data source and the user affect queues on the application, which the data source polls from time to time in order to determine whether the download files to the application. An advantage in this arrangement is that greater security is achieved because the data source does not have to identify each potential user but leaves that up to the EPN resident application. Thus information about the allowed user is not kept with the data but rather with the application that can have more extensive security checking capability. On the other hand, the data source may list the allowed users in the application and thus have a say in who gets access to the data.

The present invention more broadly utilizes an EPN server to mediate peers and present a virtual secure peer network of multiple data sources regardless of their location enabling data access devices to retrieve or submit data from any Internet enabled data source from any location. The data sources in any network may reside behind firewalls and other network security devices, on servers or computers that have EPN (Enterprise Peer Network) Client software installed provided that they are authenticated by an EPN Server software's Access Manager module by providing unique credentials. A Queue Manager in the EPN Server software then creates a unique queue for each data source that can only be accessed by the data source. The user with a browser-enabled device can then access the EPN Server by providing the necessary credentials, such as user id and password, and can then access the data in the data sources for which the user is permissioned. Each data source maintains a non-persistent connection through a polling algorithm and services the request in the queue or the data sources may be grouped and accessed through a non-persistent common network access to the EPN Server.

With respect to security, all data connections from the data source with the EPN server occur using standard SSL libraries while connections from the user data access devices are accomplished with HTTPS.

A unique machine authentication procedure is implemented (configured based on a user option) by creating a machine signature that is a combination of machine's hardware address, username and password, thus eliminating all possibilities of any masquerading device hacking the data between the data source and the user access device. This method is better than any IP address-based scheme as the machine signature is unique and constant to that particular system. The user's access to data on various pre-permissioned data sources is determined by user's rights based on its user id, password and other credentials along with the validity of the machine signature. This eliminates the need to make any changes in the network to firewalls or any of the network security devices that prohibit incoming traffic. This invention also increases the security in the network by eliminating the need for the data access device to be in the same network as the data source and granting permission to the user and the data access device to access pre-permissioned data.

This invention incorporates a granular security architecture allowing users to access data on specific data sources that the users are explicitly permissioned for and only that data and making it impossible to access any other data that isn't explicitly permissioned.

Access to files can be enabled through any Internet browser or Microsoft Windows explorer or handheld devices. The invention allows multiple users to access data on any or multiple data sources at the same time from different types of Internet enabled access devices by enabling access to pre-permissioned data.

A Peer Neighborhood can be displayed similar to the Microsoft Network Neighborhood with the difference being that peers need not be on the same Microsoft Network and can be anywhere on the Internet. Data movement between peers in a Microsoft Windows Explorer can take place using Microsoft's “drag and drop” feature.

A unique way of sending email from Internet enabled handheld devices is provided by attaching files from any data source without having to download data to the low bandwidth handheld devices. Similarly a unique method is implemented for personal information management such as email, calendar, address book by downloading from any data source inside any network, without making changes to the network and by any user with a browser enabled device in any location with Internet access. This method does not store data at any central location separate from temporary storage at the EPN Server thus increasing the privacy of the user information. The invention also provides a unique way to access data by a voice interface implementation

### BRIEF DESCRIPTION OF THE DRAWINGS

FIG. 1 depicts an overview of a secure remote access system using the Enterprise Peer Network of the present invention.

FIG. 2 depicts the message flow of a secure remote access system using the Enterprise Peer Network of the present invention.

FIG. 3 depicts the step sequence of a secure remote access system using the Enterprise Peer Network of the present invention

FIG. 4 depicts a flowchart of the client installation process of an Enterprise Peer Network of the present invention.

FIG. 5 depicts a step sequence for a client polling algorithm of an Enterprise Peer Network of the present invention.

FIG. 6 depicts an overview of a secure remote access system for a multiple user Enterprise Peer Network of the present invention.

FIG. 7 depicts the message flow of a secure remote access system for multiple users using the Enterprise Peer Network of the present invention.

FIG. 8 depicts an overview of a transmission from any remote device to any data source, including a centrally managed peer to peer architecture model in the EPN system.

FIG. 9 depicts a step sequence for setting up an access list in the present invention.

FIG. 10 depicts an overview of a security framework for the present invention.

FIG. 11 depicts flowchart for an authentication setup in the EPN system of the present invention.

FIG. 12 depicts a flowchart for the installation and configuration of an authentication agent for the present invention.

FIG. 13 depicts a flowchart for the registration of enterprise users of the present invention.

FIG. 14 depicts an overview and message flow for EPN user authentication in the present invention.

FIG. 15 depicts a flowchart for EPN registration using an EPN native authentication system.

FIG. 16 depicts a flowchart for setting up a unique key for secure communication in the present invention.

FIG. 17 depicts a flowchart for an EPN user login process of the present invention.

FIG. 18 depicts a flowchart for EPN authentication using an agent and a proxy in the present invention.

FIG. 19 is aan overview and message flow diagram for EPN authentication using an agent and a proxy in the present invention

FIG. 20 is a step sequence diagram for remote access to user email of the present invention.

FIG. 21 is a step sequence diagram for composing email using attachments from a remote machine of the present invention.

FIG. 22 is a step sequence diagram for remote access to a user's calendar of the present invention.

FIG. 23 is a step sequence diagram for remote access to a user's contacts of the present invention.

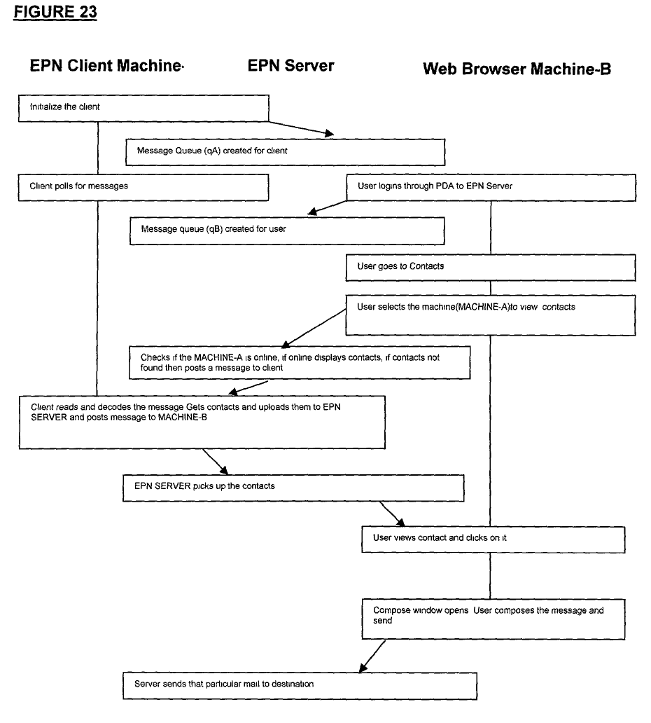

FIG. 24 is an overview and message flow diagram of secure data transfer of the present invention.

FIG. 25 is a flow chart for setting up a staging server for data transfer of the present invention.

FIG. 26 is a step sequence diagram for a scheduled data transfer of the present invention.

FIG. 27 is a message flow diagram for a secure data transfer according to the present invention.

FIG. 28 is a flow chart to set up a schedule for data transfer of the present invention.

FIG. 29 is a flow chart for an EPN wireless remote access system using email of the present invention.

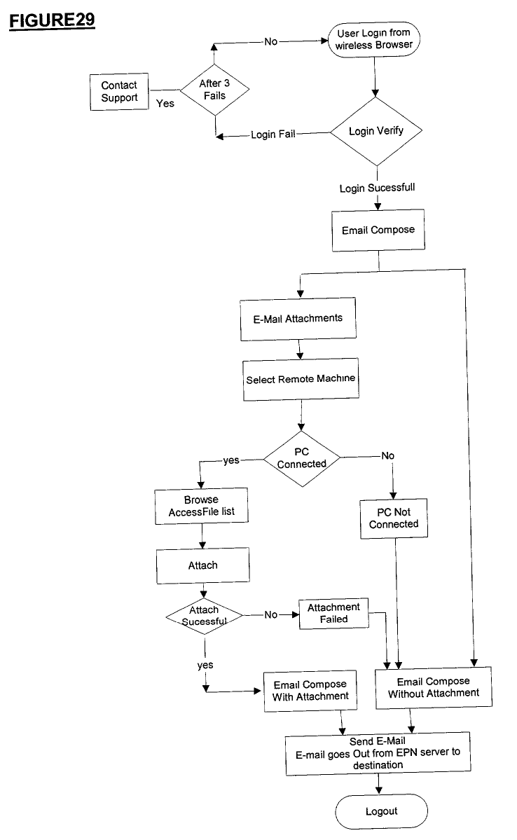

### DETAILED DESCRIPTION OF PREFERRED EMBODIMENTS OF THE INVENTION

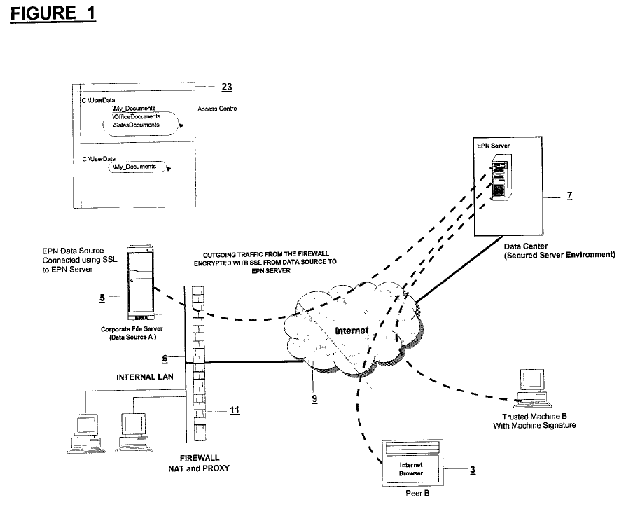

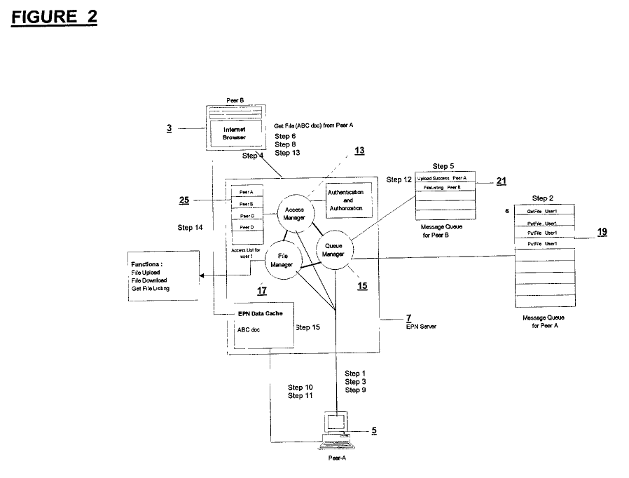

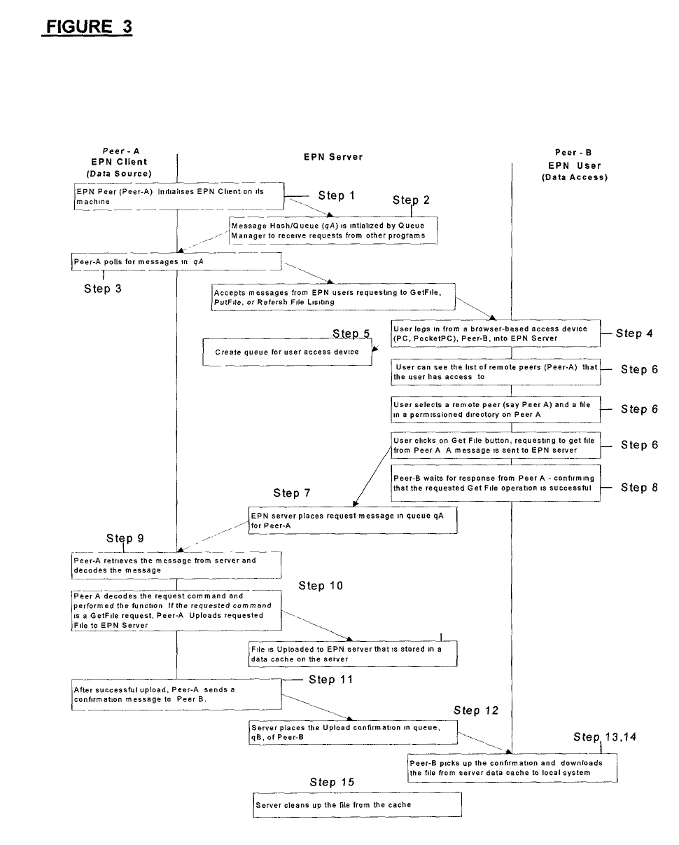

A preferred embodiment of the invention is shown in FIG. 1. The present invention provides a distributed computing system 1 that allows secure remote access by a user's access devices 3 to secure data sources on one or more machines 5, that may be within a corporate network. Message flow (how messages move between different elements of the EPN system) is shown in FIG. 2. The operation steps for providing message flow in a remote data access operation is described in connection with FIG. 3. A limited virtual network is established between a user's machines of which 3 and 5 are examples. These may be termed “peer machines”, a term referring to a set of data sources to which the user has access and the user's access devices. This network of peer machines combined with server module 7 is called an “Enterprise Peer Network (EPN)” system. The EPN system comprises a client software program (EPN client) that runs on a user's data source. A data source can be a desktop or a server machine that stores user data); an EPN Server 7 that is accessible over the Internet 9; and a standard Internet browser on the access machine 3. All three machines (the running EPN Data Source 5, the EPN server 7 and the access browser 3) are connected to the Internet. In an alternative embodiment discussed in more detail below, the Internet browser may be replaced by an extension of the Windows Explorer, a voice interface or a wireless device as the vehicle for requesting data transfers.

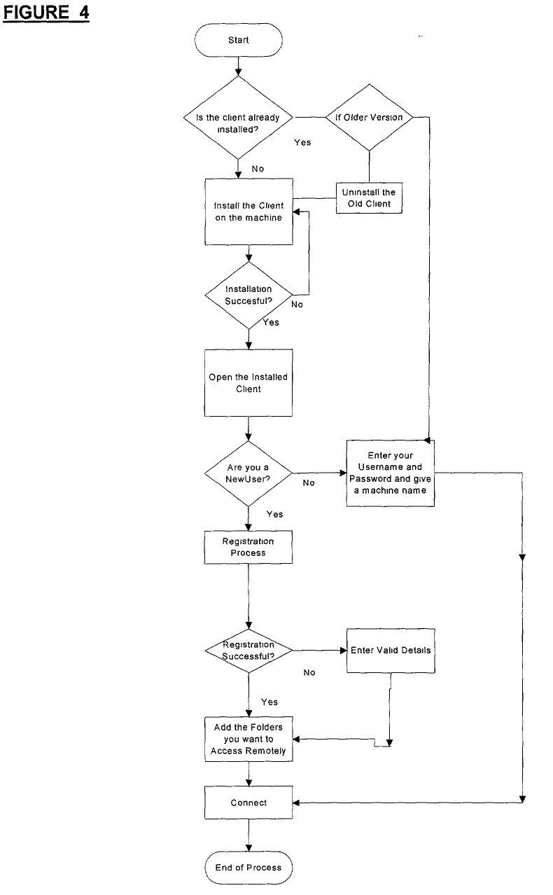

A user has a desktop 5 in the office (called Peer A in FIG. 2) that contains data that he would like to access remotely via its access machine 3. The user registers (i.e. gets and i.d. and password or uses integrated authentication to be described below) with the EPN system by registering online with the EPN server, obtains an EPN client program and installs the client program on the desktop 5 (Peer A), which then becomes a data source. Normally to bypass firewalls the user installs this directly on the computer. The steps for the installation are shown in FIG. 4. This installation proceeds by virtue of the user also having access to the peer machine as one with access to the corporate network.

The EPN client program starts on the user's data source (Peer A) typically at system startup and connects to the EPN server (FIGS. 2, 3 Step 1) over a HTTP tunnel. (Note that in FIG. 2, steps are numbered by the isolated numbers—i.e. without lead lines—on the Figure.) FIG. 2 shows the connections and FIG. 3 the sequence of operations. The client uses a simple message protocol to communicate with the EPN server. The protocol encodes application and user data packets using HTML format. The data sources typically reside behind a firewall 11. The firewall 11 sees the client communication as HTTP traffic coming from a standard browser indistinguishable from an authorized machine on the corporate internal network. The packets are encrypted using Secure Socket Layer libraries, so that the data cannot be tampered with en route. In essence, client to server communication is conducted entirely using HTTPS.

Access controls can be set up by the user or corporate administrator to restrict access by the client to a limited set of data by a master access list. The master access list can be set up using the EPN client on the user's peer (data source). It can further be modified within a subset of the master access list by using browser-based access to the EPN server. Access permissions can be set up at the directory or file level, which is a much finer granular security than traditional VPN solutions. Granular in this sense refers to the ability to designate specific file directories or even individual files. The access machine will not have access to any other part of the corporate network nor will it be able to access any data beyond what is set in the access list and the user's own email, contacts and calendaring functions.

As shown in FIG. 2, the EPN server consists of several modules. These may include an Access Manager 13 (to control authentication, authorization and management of user communication), a Queue Manager 15 (to manage the creation of the queues and to secure operations on the queues), a File Manager 17 (to manage transport of data/files between peers and the EPN Server) and a Report Manager—not shown—(to print detailed and summary reports on usage). The Access Manager 13 helps set access lists for user peer machines with data, collects and maintains access lists with permissions in encrypted form on the EPN server, and screens incoming requests from data accessors 3.

The EPN server's Access Manager 3 authenticates Peer A 5 based on the user's login id and password, and creates Request (qA) queues 19 for the contacting peer (FIGS. 2, 3, Step 2). The EPN server contains a Queue Manager 15 that manages the queues, in memory or inside a database for persistence. The details of authentication procedures are part of this invention and are described below. When a user accesses the system from a browser 3, a separate queue 21 is established by the queue manager 15 (FIGS. 2, 3, Step 4).

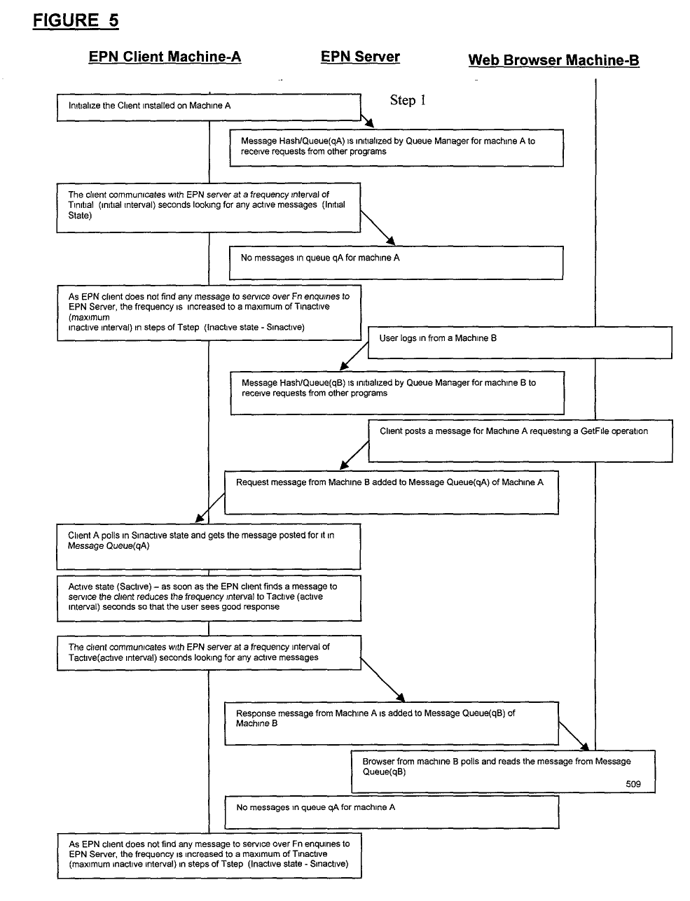

Once the queues 19, 21 are created, the EPN client polls (FIGS. 2, 3, Step 3) the EPN server looking for any requests in its request queue qA 19. This default state of EPN client programs that run on user's peer machines polls the EPN server at periodic intervals and closes the connection after each pole. The polling interval is adjusted by the client based on a polling algorithm that ensures good response at the time of usage while conserving network bandwidth when not in use. The polling algorithm is described in FIG. 5.

The term user's Peer Neighborhood refers to a set of data sources at one or multiple locations configured by the user or shared by other users with the user. A user can use any machine that runs a browser to access peer machines in the user's Peer Neighborhood as determined by an access list 23 for that user. A user can log in from any standard browser 3, such as Internet Explorer or Netscape Navigator, from any machine (Windows, UNIX or Mac) to the EPN server, using a given login id and password (FIGS. 2, 3, Step 4). Once authenticated the user becomes Peer B (for the user coming from an access device 3), the EPN server creates a Reply (qB) queue 21 so that it can receive responses (FIGS. 2, 3, Step 5). As mentioned, in an alternative embodiment an extension of the Windows explorer may be utilized in place of a browser.

The communication from the browser to the EPN server is based on secure HTTP (SSL) to ensure security. In essence, SSL-based secure transport is used in both legs of communication—client-to-server and browser-to-server.

Using the browser interface 3, the user looks (FIGS. 2, 3, Step 6) at the list of peer machines available 25 configured or interfaced in the Peer Neighborhood. The user selects a peer machine (FIGS. 2, 3, Step 6) and looks at the listing of files that are configured previously on the peer for remote access. The user navigates through the listing and selects a file to be downloaded (FIGS. 2, 3, Step 6) (“Get File” operation) to the remote machine 3 (Peer B) (FIGS. 2, 3, Step 6). The request is communicated (FIGS. 2, 3, Step 6) to the EPN server 7. The browser polls the EPN Server (FIGS. 2, 3, Step 8), looking for a response in its reply queue qB 21.

The EPN Server verifies the request by looking into the access control list and enters the request into qA (request queue for Peer A) (FIGS. 2, 3, Step 7), and allows the EPN client polling from Peer A to pick up (FIGS. 2, 3, Step 9) the request.

As the EPN client polls qA, it finds and picks up the request message (FIGS. 2, 3, Step 7). The client decodes the message to find that a file on the peer machine needs to be picked up and sent out. The client uploads the file to the EPN Server over the same encrypted channel (FIGS. 2, 3, Step 10). The file is stored in a data cache on the EPN Server for subsequent pick up (FIGS. 2, 3, Step 10). The client also sends a response to EPN server so that the response is deposited in qB 21 (reply queue for the user coming in from Peer B) (FIGS. 2, 3, Step 11,12).

The browser program finds the response message in its reply queue—qB (FIGS. 2, 3, Step 13), and finds the location of requested data file in EPN server's data cache. The file is downloaded to the desktop 3 (Peer B) (FIGS. 2, 3, Step 14) and upon successful completion the file is cleared from the cache (FIGS. 2, 3, Step 15).

A “Get File” operation (basically downloading a file from a data source to a local machine or accessing machine) is complete once the file is downloaded to the desktop and deleted from server data cache. Additional functions such as “Put File” (uploading a file from the local file or accessing machine to the data source) and “Open File” (a combination of downloading a file and opening the file using a local application) are available that use the same mechanism of underlying communication.

Alternatively, the user could upload data to the EPN server for long term storage on the EPN server, which the user could retrieve by use of a browser. This involves the user uploading the data using EPN or manually from any other data source to the central storage, and picking up the data from any other location having a browser.

Persons of skill in this art will notice the advantages of the EPN system for Remote Access to be that the architecture is such that data accessor and data source are disconnected processes and joined only by asynchronous communication using queues; that no changes are required in the corporate firewall or network configurations, which alleviates the burden for network administrators and simplifies over all remote access management.

The EPN remote access is easily extensible to retrieve user's PIM information (Personal Information Management, which includes email, calendaring, and contacts) from a remote peer, from one and only copy of PIM database maintained by the user; the PIM data can be displayed right inside the accessing browser for easy navigation and usage.

Multiuser Aspects

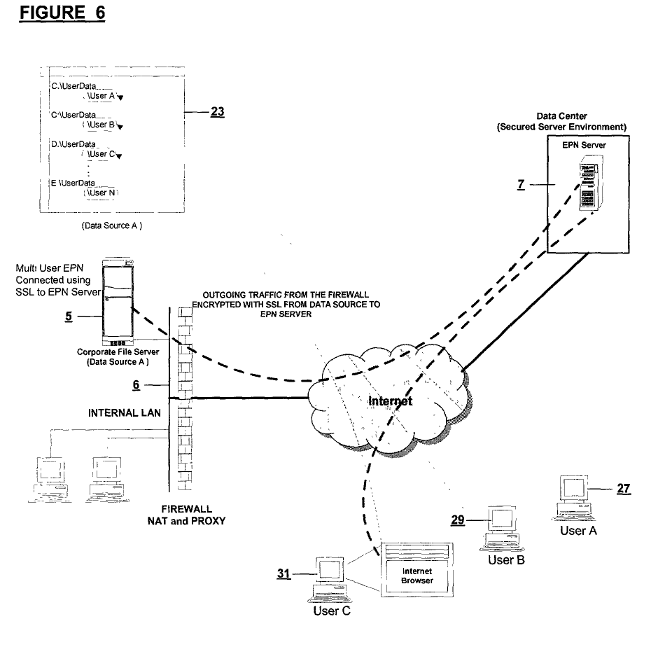

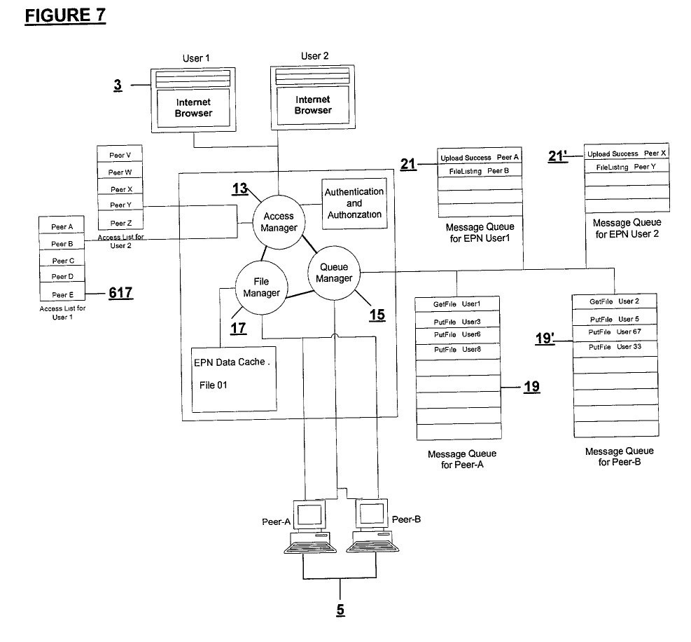

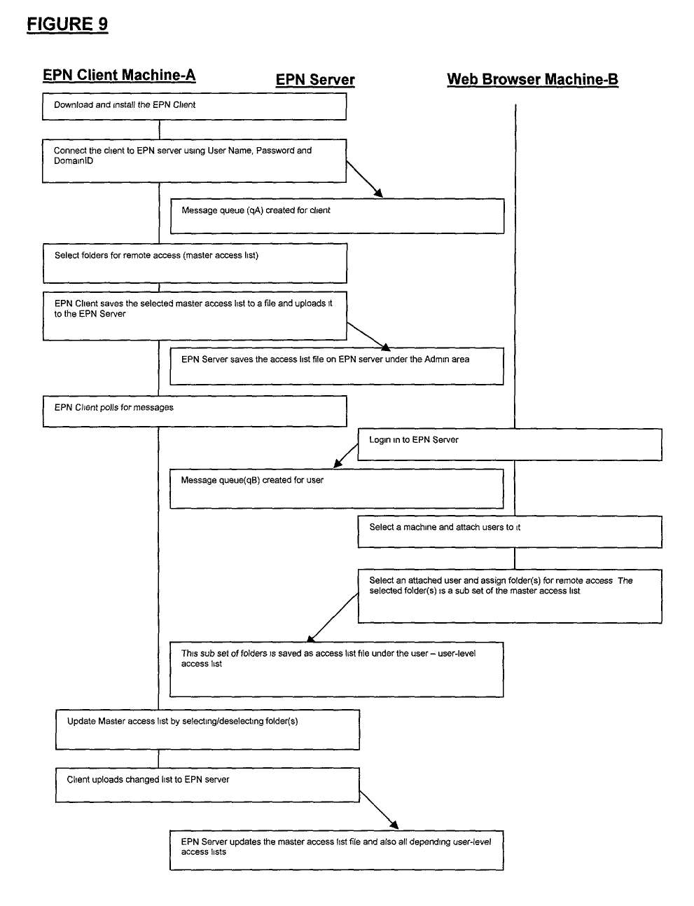

A multi-user EPN embodiment is depicted in FIG. 6 and FIG. 7. This embodiment describes a multi-user version of EPN system that allows multiple users to log in and access data residing on the same peer machine. The peer machine could e set up by an administrator or a user, and could access data on other user's machines, 27, 29, 31. The EPN Multi-User system is useful for corporations, small to large, where they have file servers 6 to reliably host user data. A modified version of EPN client, EPN MU client, is installed on the file server that controls data access to a selected group of users—users and access lists 23 are set up and managed by the administrator. The procedure for setting up access lists is shown in FIG. 9. A user's Peer Neighborhood can consist of a file server 5 (running an EPN MU client) and other desktops (running a single-user version of EPN client) and still access data across all peers seamlessly.

The EPN system requires an administrator to install an EPN MU client on the file server 5, add users to be able to access the machine and set up directories and permissions that each user 27, 29, 31, is allowed to access. Individual users have few privileges in modifying their access lists.

A single instance of an EPN MU client runs on the file server, while access lists and interface queues 19, 19′, 21, 21′ are created and maintained on the EPN server 7 for each allowed user. This method ensures that Access Manager 13 and Queue Manager 15, which are part of the EPN server, manage user communication in a manner similar to that of the single-user version of EPN. It will be appreciated that the application design is consistent between single and multi-user modes and maintains user-level controls to ensure a secure and scalable system.

Managed Peer to Peer System

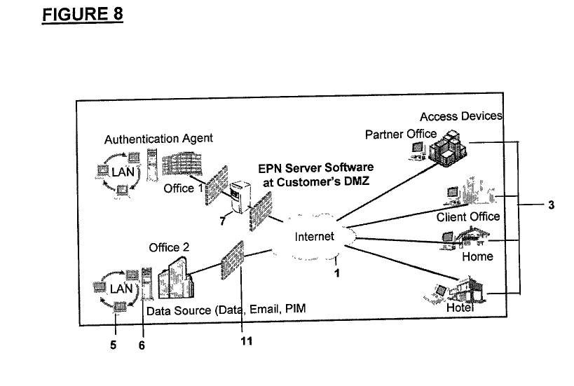

A still further embodiment of the invention, as shown in FIG. 8, involves a transmission from any remote device 3 to any data source 6. This includes the implementation of a “Managed Peer to Peer” architecture model in the EPN system, where peer-to-peer communication is enabled and managed via a central manager server 7. The manager in this embodiment is the EPN server that helps manage and enforce authentication, secure transmission and access controls to ensure the EPN system as a Secure Remote Access solution.

Here the EPN server 7 maintains separate and secure channels of communication with the EPN client at data source 6 and at a browser at a remote accessing device 3. The EPN Server maintains request and reply queues to enable asynchronous communication so that no program awaits a response, which ensures high performance and scalability. EPN systems can handle different types of requests with the help of queues, which make the location of an accessing program, the communication method, the protocol, and the type of access device to be completely transparent. This property makes the EPN system easily extensible to include new access devices as well as other types of peer machines and new types of requests.

The user interface side of the system is built using a ‘thin-client’ model, as a result of which the core EPN logic remains on the EPN Server itself. Thin-client approach improves performance (less data traveling over the net), extensibility (adding new device types is easy) and maintainability (easier to upgrade and maintain software on the EPN Server), and enforcement of security and policies. As a result of using queues on the EPN Server, remote peers and accessing browsers can operate without affecting the operations of each other.

Additional controls are available so that disgruntled users (or any hackers) cannot change any of the function parameters or trample on others' access lists or data. Here one normally has access only to the data on a server and not to other files.

Authentication Procedures

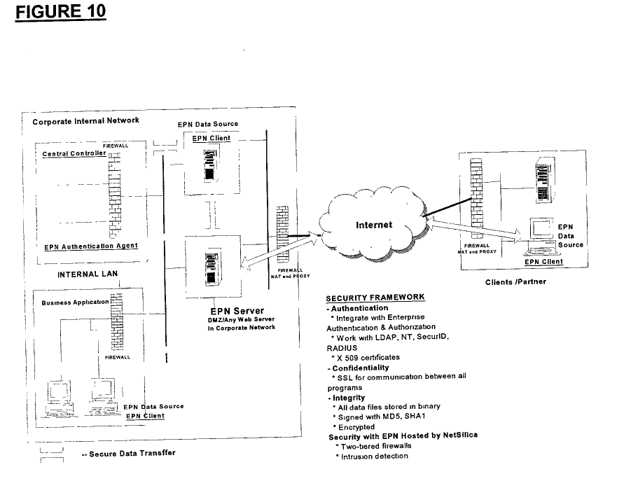

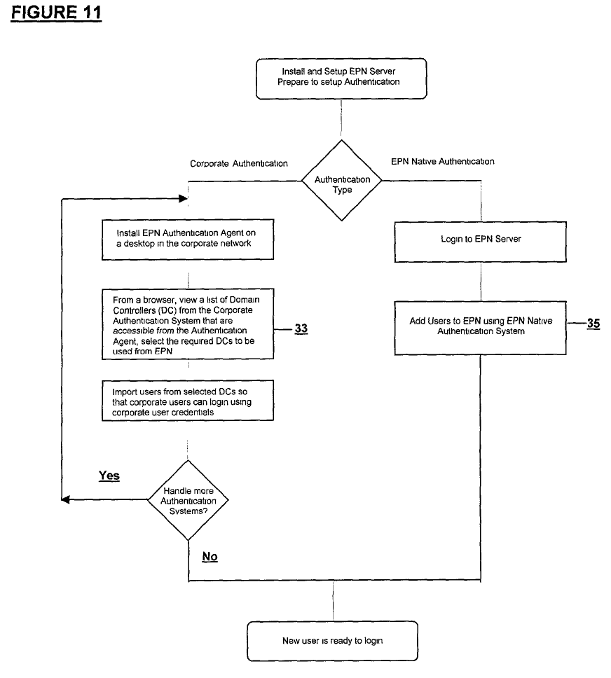

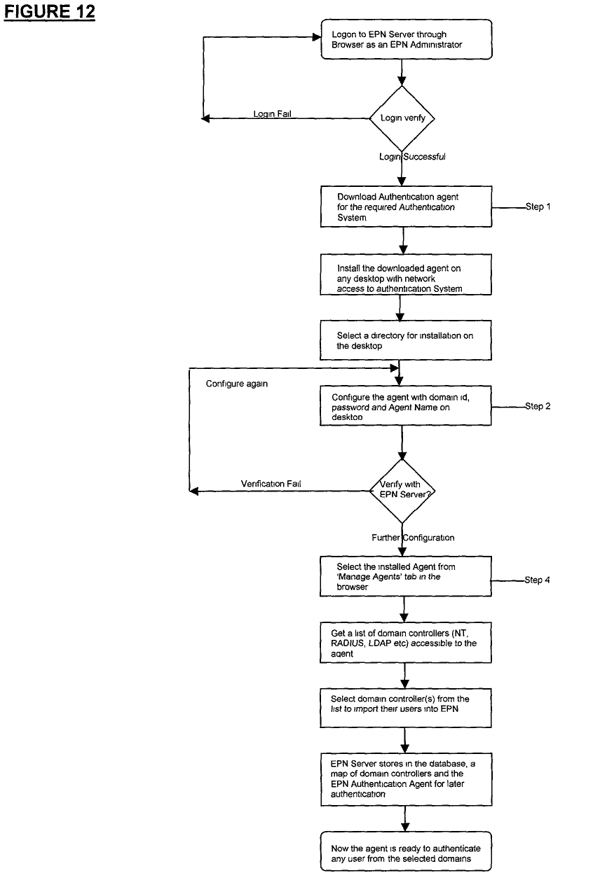

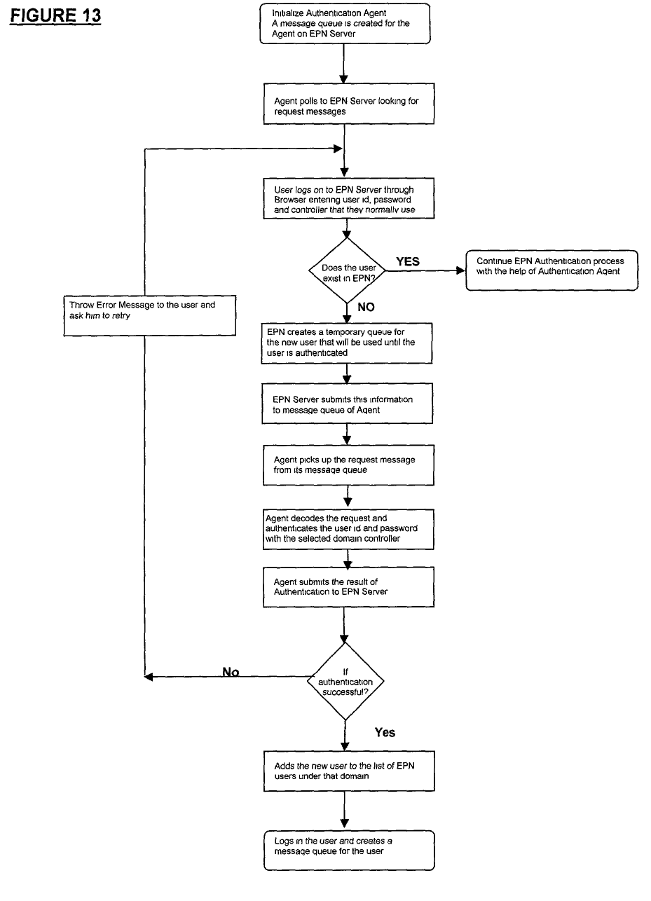

The authentication procedures utilized to provide security of the EPN system are components of the Security Framework aspects of EPN and are described in FIG. 10. FIG. 11 depicts an overview of the authentication setup in the EPN system. It shows that users can be set up in the EPN system 33 using EPN's native authentication system 31 or integrate with a corporate authentication system. The procedure for installation and configuration of the EPN authentication agent is described in FIG. 12. Once the agent is set up, a new user logs into EPN using corporate credentials as described in FIG. 13.

Integrated Authentication

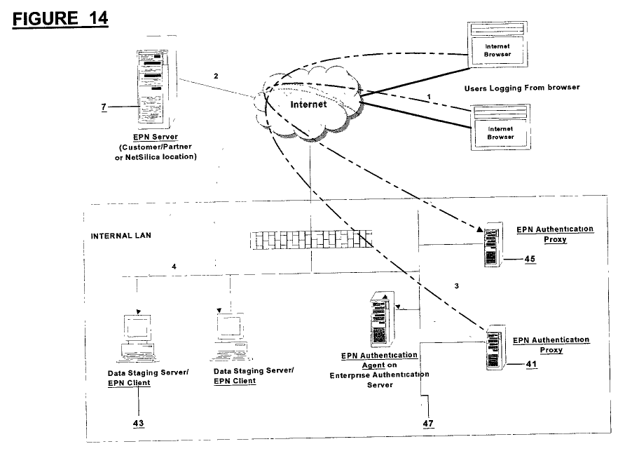

As shown in FIG. 11, the invention provides a user id system or the ability to work with a Company's internal authentication scheme 33 (such as Active Directory Services, Windows NT Directory Services, RADIUS, RSA SecurID, UNIX). Users of the invention can install an Authentication Module (FIG. 13, FIG. 14, 41) within a corporate premises 43, with an Authentication Agent 45 running on any machine that has network access 47 to Company's Authentication Server 49 (for example—an NT Domain Controller server running NT Directory Services) as well as an EPN Server 7. The Agents use SSL protocol and private client keys to ensure encrypted communication with the EPN Server 7 so that a user's credentials and authentication status are not tampered with.

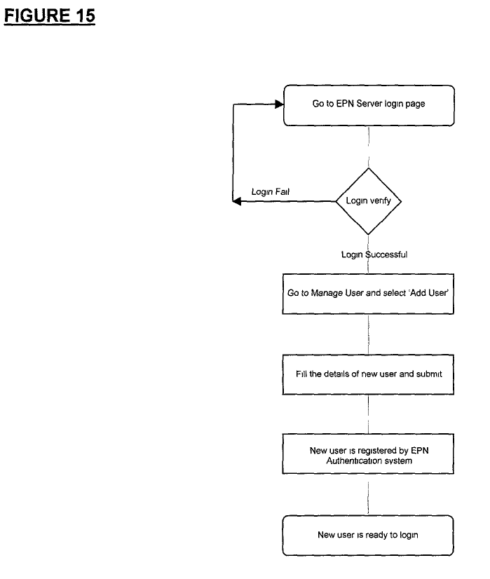

An EPN administrator can ‘import’ all corporate users into an EPN system by installing single or multiple Authentication Agent programs as shown in FIG. 12 in a network that can work with the same Corporate Authentication System or different systems. The administrator can use an EPN Native System if he needs to set up any users explicitly as shown in FIG. 15.

An Authentication Agent is installed by following a few simple steps and is configured to communicate with a Central Controller. The Agent uses a uniform higher-level API that masks the details of underlying communication with the Company's authentication system (such as Java Authentication and Authorization Service—JAAS). JAAS integrates with the native API supplied for the authentication system vendor or other standard application code.

To improve overall security, none of the credentials of a corporate user (including password) need be stored on any of EPN machines. An Agent helps authenticate a user directly against the user's internal corporate user database, hence even when passwords are changed it is of no consequence for EPN usage.

The Agent uses the same communication method that is used by the EPN Client for data transfers. That is—the Agent uses outbound traffic (from inside a corporate network) by polling a queue on the EPN Server for request messages. The EPN Agent handles only authentication requests from users/EPN programs and passes them on approval with the Company authentication system.

The EPN Authentication Agent does not require any network changes in the customer's environment, hence the functioning of the EPN system is not affected even if there is a change in the internal network set up and configurations (IP addresses). This is unlike most solutions in the market that also run authentication agents within the LAN, but have to reconfigured if there is any change in the network (such as IP addresses). EPN Agents do not require reconfiguration to accommodate such changes.

A highlight of this authentication process is that the user ids of all extranet users, irrespective of the communication method used and the data source being accessed, can be centralized in the Enterprise Authentication Central Controller 49 for complete control and efficient management. Whenever corporations provide extranet access to users from their partner or customer organizations there is no simple mechanism to set up and manage ids and passwords, which is usually in violation of their corporate security policy. EPN extranet access helps by creating extranet user accounts in the same extranet corporate authentication system that they normally use. EPN Authentication Agent can not only handle user login and password but also ‘import’ user authorization (access permissions to specific drives and folders) details that are set up in the corresponding authentication system.

The EPN Authentication Setup as described in FIG. 12 will now be described as a series of steps. Except where expressly stated these steps need not be performed in the indicated order, nor do these steps exclude other steps and processes between enumerated steps. In Step 1, an EPN administrator identifies a machine (desktop/server) inside a corporate network to set up an EPN Authentication Agent. The administrator logs into EPN from a browser on the selected machine and downloads an Authentication Agent that can work with the target authentication system. The Agent is installed following a few simple steps listed in FIG. 12 below Step 1 and configured to communicate with a Central Controller for the target Authentication System.

Step 2: After installation, the Authentication Agent is registered with the EPN Server by providing domain credentials using a message protocol.

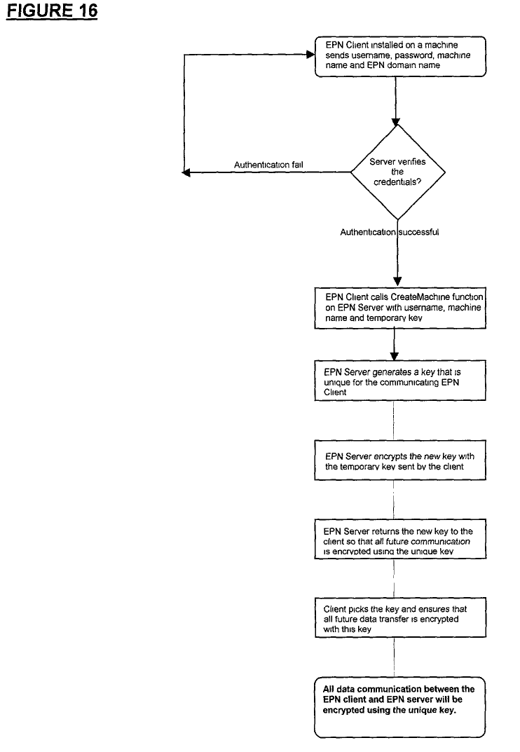

Step 3: In response, the Agent obtains a special shared key as described in FIG. 16 that is known only to the EPN Server and the Agent. This key is used to encrypt all subsequent communication between EPN Server and Agent. This additional encryption is used on top of SSL transport for additional protection. The key is changed from time to time by the EPN Server.

Step 4: EPN Administrator logs onto a browser, identifies the newly installed Agent (from an Agent list) and ‘imports’ all domain controllers that the Agent has access to. (See FIG. 12)

Step 5: At this point, a corporate user is ready to use EPN. EPN uses a lazy registration technique (described in FIG. 12)—described as follows: a corporate user is not set up in EPN by default. When a user logs in to EPN for the first time into EPN, EPN authenticates the user by consulting the domain controller (that the user chooses) with the help of an EPN Authentication Agent. Upon receiving success from Central Controller of the corporate authentication system, EPN import's the user and creates an environment within EPN for the new user. See FIG. 13.

Step 6: Users can be set up directly within EPN using an EPN Native Authentication system for convenience. The Administrator can still manage all EPN users, having different authentication systems, from a single browser interface.

User Authentication Process

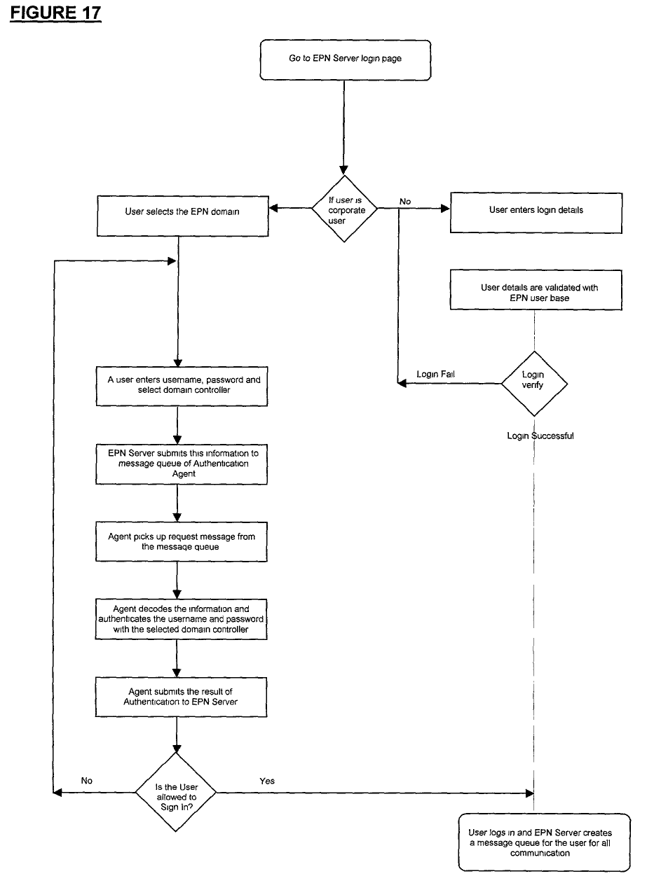

The User Authentication Process is described in FIG. 17.

Step 1: Whenever a user (from a browser) or an EPN program (EPN Client) attempts to login to EPN, they communicate with EPN Server, along with credentials such as—user id, password and EPN Domain name (logical grouping of user ids and data sources). The EPN Server checks the validity of the EPN user, finds the Agent (by looking it up in a User ID map maintained on the EPN Server in a secure database) and passes user credentials to the Agent.

Step 2: The results are sent back to the EPN Server to allow/disallow the requesting user (or program) to access the EPN system.

Step 3: When a user logs in for the first time, he does not have any context within EPN to use remote access or data transfer facilities. A temporary queue is created (“lazy registration” FIG. 13) by EPN Server and used while the user credentials are authenticated by a corporate authentication system. After successful authentication, the user is ‘imported’ into EPN for regular use.

Proxy Implementation of Authentication

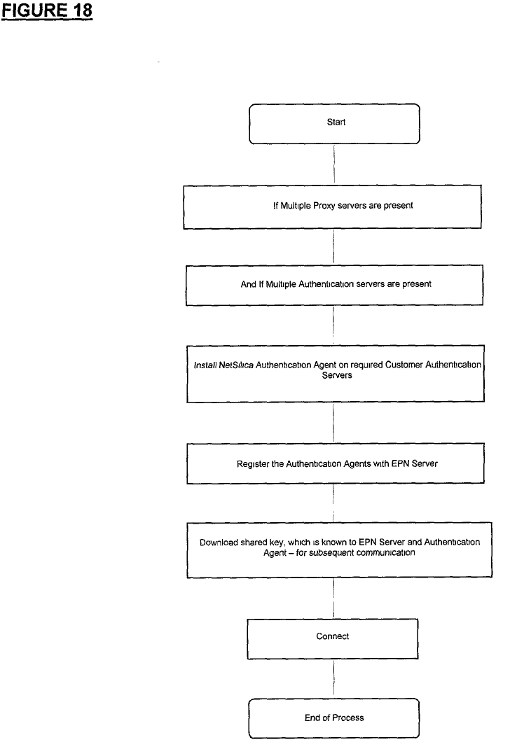

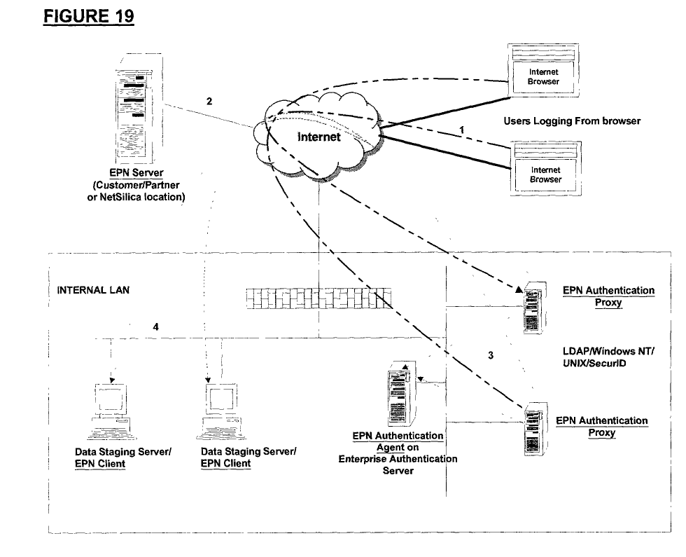

EPN Authentication may be implemented using a Proxy (FIGS. 18, 19), which allows multiple authentication agents to be handled via one proxy.

Depending on customer requirements EPN may have to install an Authentication Agent on their Authentication server. In which case EPN uses an additional program called the EPN Authentication Proxy—that runs on a machine within the corporate network, and handles communication between EPN Server and an Authentication Agent.

As shown in FIG. 19, customers can install an EPN Authentication Module within corporate premises, with an EPN Authentication Agent running on the Company's Authentication Server (for example—NT Domain Controller server running NT Directory Services) with no requirement to connect to the Internet and an Authentication Proxy installed on any desktop that can connect to an EPN Server as well as to the Authentication Agent. The Proxy uses SSL-based communication and is a simple pass through between the two programs. One may install and have multiple Proxy programs that talk to the Agent.

EPN based authentication (using a Proxy) set up and process is described in the following steps.

Step 1: After installation, the Authentication Agent is registered on the EPN Server using a message protocol to obtain a special shared key that is known only to the EPN Server and the Agent. This key is used to encrypt all subsequent communication between EPN Server and Agent.

Step 2: When ever a program (EPN Client) or a user (from a browser) attempt to login to EPN, they communicate with EPN Server first, along with credentials such as—user id, password and account (customer or account name). EPN Server checks the validity of the EPN account, finds the address of corresponding EPN Authentication Proxy (by looking up in a User ID map maintained on the EPN Server in a secure file) and passes user credentials to the Agent, via the Proxy.

Step 3: The Proxy uses the same communication method that is used by EPN Client for data transfers. That is—Proxy uses outbound traffic (from inside corporate network) by polling a queue on the EPN Server for request messages. EPN Proxy handles only authentication requests from users and passes them on to the Agent for approval with the Company authentication system.

Step 4: The Agent is installed on one of the Authentication Servers.

Step 5: The results are sent back to the Proxy, which in turn is returned to EPN Server to allow/disallow the requesting user (or program) into EPN.

Authorization Procedures

A detailed authorization procedure for data resources is described in FIG. 9. The principle steps are as follows: Remote access to a data source is controlled by the owner of the data source or an administrator. An access list can be set up on the data source using the EPN client interface where a list of folders can be specified for remote access. This master access list cannot be changed from any browser or other means except by the owner of the data source. An owner can share this data with other users by setting up user level access lists from any web browser. If the data source happens to be a file server it is typically set up by an administrator who would set up the multi-user access. The master access list once created is stored on the EPN server along with other user level access lists.

Referring to FIG. 9, an administrator or owner of the data source sets up the master access list after downloading and storing the EPN client on the data source. The owner goes through the list of folders accessible on the data source and selects a subset of the folders for remote access, creating the master access list. The EPN client saves the master access list to a file and uploads it to the EPN server.

The EPN server saves the master access list under an area allocated for the owner. The owner can log in the EPN server from a browser at any later time, select the data source and attach users to it and create a user level access list which is a subset of the master access list.

The user level access list is created in a file and is stored under the user's designated area on the EPN server.

The EPN System also provides reports to the administrator on each user's operations and activity. The reports help the administrator understand the usage patterns, monitor for unwarranted activity and tighten access lists.

For authentication of data communication the EPN system can use pluggable authentication modules (e.g. RSA SecurID) that can be configured based on a customer's requirements.

The EPN system can choose whatever key length for encryption is officially allowed and the supporting machines can handle encryption of all data communication and data storage.

All communicating programs are authenticated two-way (i.e. the client can provide a certificate to prove authenticity) using SSL and also using additional keys. SSL-based encryption (Secure Socket Layer) is used as the base transport for all communication paths that flow over the Internet (or Intranet) via the EPN Server (validated by a server certificate issued by a qualified Certificate Authority).

In order to ensure non-repudiation, EPN uniquely identifies each communicating EPN Client (from a Data Source or Authentication System) with a special key (generated at the time of registration) that is used to encrypt all subsequent communication. This encryption is used on top of underlying default SSL-based transport.

Different communication paths covered in EPN are: EPN Authentication Agent<->EPN Server on the web; EPN Client<->EPN Server on the web; Web browser<->EPN Server on the web; and Wireless device<->EPN Server on the web.

To enable the secure handling of customer data files (including virus scan and encryption), customer data files are passed through the EPN server over a Secure Socket Layer connection, which ensures secure, non-tampered or non-duplicable data transfer. Virus scan facility are integrated with the EPN server for additional protection.

The security measures implemented on the EPN Server include all EPN system data (and log data) being stored in files, on the server machine that hosts the EPN server software. The data is written in binary form into the files. The files can be further encrypted (at a customer's selection, based on the capacity of hosting machine to handle repeated encrypt/decrypt operations). The EPN system uses MD5 and SHA1 signatures to ensure the data integrity of the stored files so that they are not moved to other machines, content changed or replaced by other similar files.

For further security the queue manager ensures the authenticity of the requesting program before accessing a queue to enqueue or dequeue messages. The EPN Client passes a special signature to identify the peer, and each server access is screened for tampering or break-in.

The Client Polling Algorithm is described in FIG. 5. As a security measure, an EPN Client does not maintain persistent connection with EPN Server. It opens a network connection with EPN Server, picks up any request messages in its request queue or posts messages in the queue of another EPN program and closes the connection, similarly to a traditional HTTP request. The client communicates with the server at a polling rate that is determined based on the client's state. The allowed states for an EPN client to be in are the following:

Initial state (Sᵢₙᵢₜᵢₐₗ)—right after the initial start up of EPN client, typically when the machine is booted. The client communicates with EPN server at a frequency interval of Tᵢₙᵢₜᵢₐₗ (initial interval) seconds looking for any active messages.

Active state (S_{active})—as soon as the EPN client finds a message to service the client reduces the frequency interval to T_{active} (active interval) seconds so that the user sees good response.

Inactive state (S_{inactive})—if EPN client does not find any message to service over Fₙ enquiries to EPN Server, the frequency is increased to a maximum of T_{inactive} (maximum inactive interval) in steps of Tₛₜₑₚ.

Key parameters such as Tᵢₙᵢₜᵢₐₗ, T_{active}, T_{inactive} and Tₛₜₑₚ intervals and Fₙ are tunable within the client program. A simple relationship between the numbers is T_{active}<Tᵢₙᵢₜᵢₐₗ<=T_{inactive}. EPN programs can be built for specific response requirements and special network conditions.

EPN—Remote Access to Commercial Email/PIM packages)

The EPN System in addition to providing file transfer between a data source and a user implements PIM functions. People use computers for several tasks, including most importantly running and maintaining Personal Information Management (PIM) functions. PIM functions relate to a user's Email, Contacts and Calendar functions. Many users use packages such as Outlook, Outlook Express and Lotus to manage their PIM data. These packages work well while the user is connected to office LAN, but do not make the PIM data readily available when the user travels outside the office network. No matter which connectivity they use to log in to office network, accessing their own PIM data is complex and unreliable.

PIM package vendors such as Microsoft and Lotus started providing Web extensions to their PIM packages (Outlook, Lotus). These web extensions are typically expensive, difficult to set up and require network changes (e.g. firewall adjustments) that are complex to maintain. Also these extensions result in security issues that require expertise to resolve. Hence these web extensions are not that popular.

Other third party solutions are available that run a central web server, and expect the users to copy their PIM data to the central server so that the central copy is accessible from anywhere using a web browser. This however involves leaving ones trusted environment to an unknown third-party central repository and requires synchronizing the PIM data with the source.

The present invention uses core EPN server-mediated secure managed peer-to-peer technology, where an EPN Client can be installed at the data source—machine containing PIM data (desktop or a server) and can provide instant remote access to the user's most current copy of PIM data. PIM data does not leave the machine, nor secure corporate network, data is not copied to any third party server and no changes to network.

The same PIM data is accessible from a wireless device, or even using a voice interface for convenience. The back-end technology is still the same, except for additional translation that can be managed by EPN Server software. The solution can be deployed to a large customer by deploying EPN Server software within the customer's DMZ, as well as Small-to-Medium customers by hosting EPN Server within a vendor or Partner's premises.

E-mail Reading

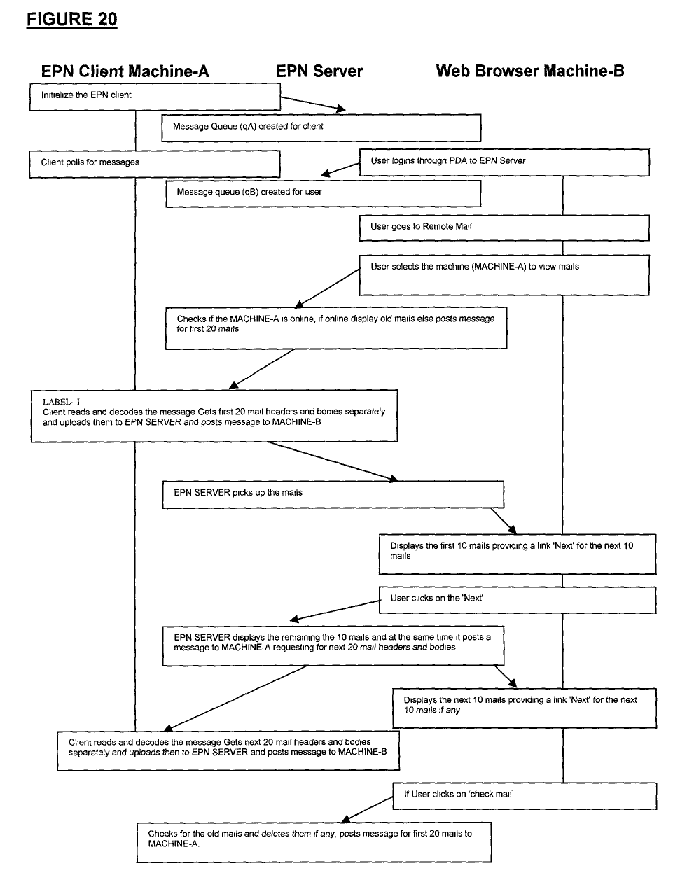

In an embodiment for reading e-mail where there is a single client machine an EPN server and a Web Browser machine, the first step is to initialize the EPN client. (See FIG. 20). A message queue is then created for the client on the EPN server. A user then logs in through its PDA to the EPN server. A message queue is then created for the user on the EPN server. The order of these operations is not critical. The user then goes to a remote mail utility and selects the EPN client machine to view mails. The EPN server checks to determine whether the EPN client machine is online. If found online, the EPN server displays old mails and/or posts messages for the first 20 mails.

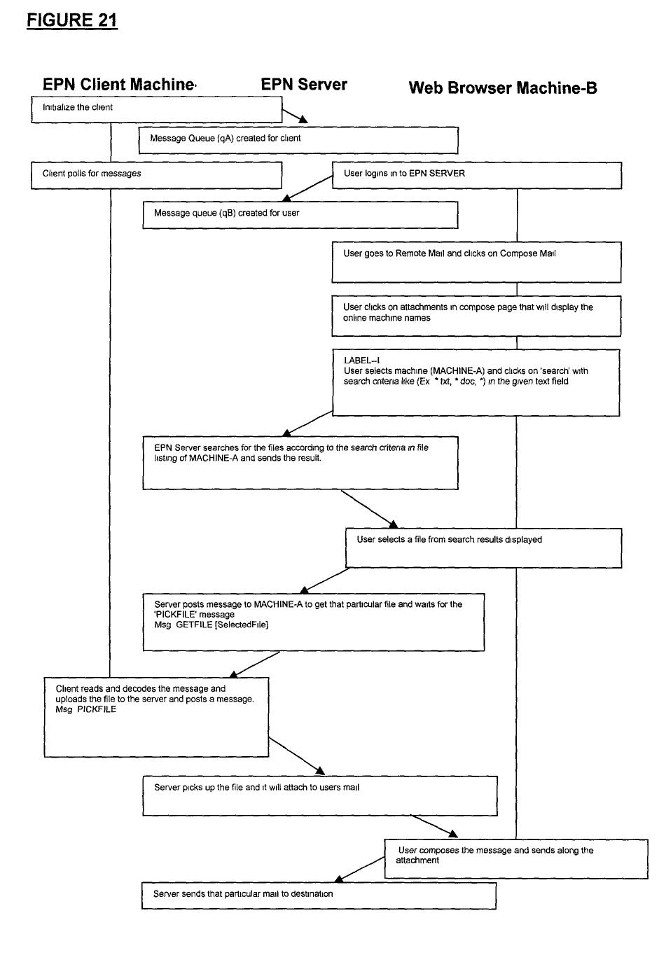

The client then reads and decodes the message and gets the first 20 headers and bodies separately and uploads them to the EPN server and posts mail message to the browser. The EPN server then picks up the mails and the browser displays the first 10 mails and provides a link to the next 10 mails. The system then awaits user input indicating it wishes to receive the next group of messages. When the browser responds to the user clicking “next” the EPN server displays the next 10 mails and posts a message to the EPN client requesting the next 20 mail headers and bodies. The EPN server then communicates with both the EPN client and the browser. The EPN client reads and decodes the messages and gets the next 20 mail headers and bodies separately and uploads them to the EPN server and posts a message to the browser; the browser displays the next 10 mails and provides a link “next” for the next 10 mails if any. If the browser user clicks on “check mail” the EPN server checks for the old mails and deletes them if any, and posts messages for the first 20 mail s to the EPN client. The systems all provide a mechanism for composing email. The system also provides a mechanism for composing email messages using attachments from a remote machine (EPN data sources). See FIG. 21. The user logs on to the EPN server and starts to compose a new email message. The email composer is a standard screen except that the user has the ability to pick up files from the data sources to which the user has access. When the user selects files from the remote data sources, the EPN server sends out request messages to the appropriate data sources, picks up the files and attaches them to the email message of the user.

Calendaring

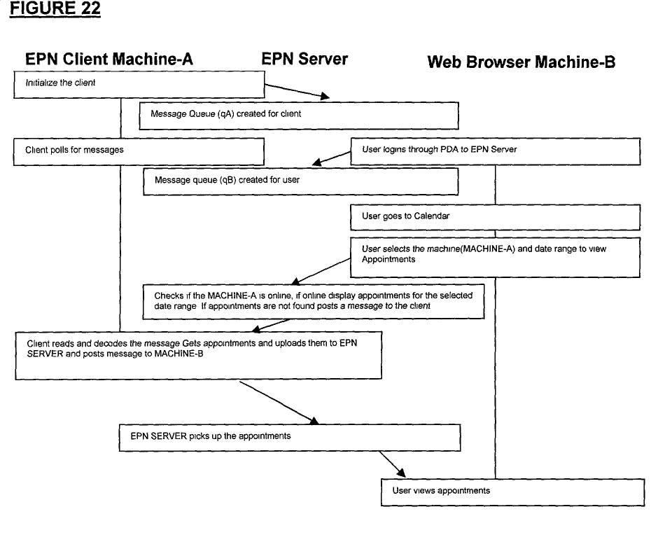

In an embodiment (See FIG. 22) for having remote access to a commercial calendaring program such as the Outlook calendar, where there is a single client machine an EPN server and a Web Browser machine, the first step is to initialize the EPN client. A message queue is then created for the client on the EPN server. A user then logs in through its PDA to the EPN server. A message queue is then created for the user on the EPN server. The order of these operations is not critical. The user then goes to the calendar utility and selects the EPN client machine to view appointments. The EPN server checks to determine whether the EPN client machine is online. If found online, the EPN server displays the appointments.

The client then reads and decodes the message and gets the first 20 appointments and uploads them to the EPN server and posts messages to the browser. The EPN server then picks up the appointments and the browser displays the first 10 appointments and provides a link to the next 10 appointments. The system then awaits user input indicating it wishes to receive the next group of appointments. When the browser responds to the user clicking “next” the EPN server displays the next 10 appointments and posts a message to the EPN client requesting the next 20 appointments. The EPN client picks up the request message from the queue on the EPN server and communicates with the local Outlook instance and extracts the requested set of appointments.

Contact Review

In an embodiment for having remote access to Outlook contacts, where there is a single client machine an EPN server and a Web Browser machine, the first step is to initialize the EPN client. A message queue is then created for the client on the EPN server. A user then logs in through its PDA to the EPN server. A message queue is then created for the user on the EPN server. The order of these operations is not critical. The user then goes to the contacts utility and selects the EPN client machine to view contacts. The EPN server checks to determine whether the EPN client machine is online. If found online, the EPN server displays the contacts.

The client then reads and decodes the message and gets the first 20 contacts and uploads them to the EPN server and posts messages to the browser. The EPN server then picks up the contacts and the browser displays the first 10 contacts and provides a link to the next 10 contacts. The system then awaits user input indicating it wishes to receive the next group of contacts. When the browser responds to the user clicking “next” the EPN server displays the next 10 contacts and posts a message to the EPN client requesting the next 20 contacts. The EPN client picks up the request message from the queue on the EPN server and communicates with the local Outlook instance and extracts the requested set of appointments.

Secure Data Movement

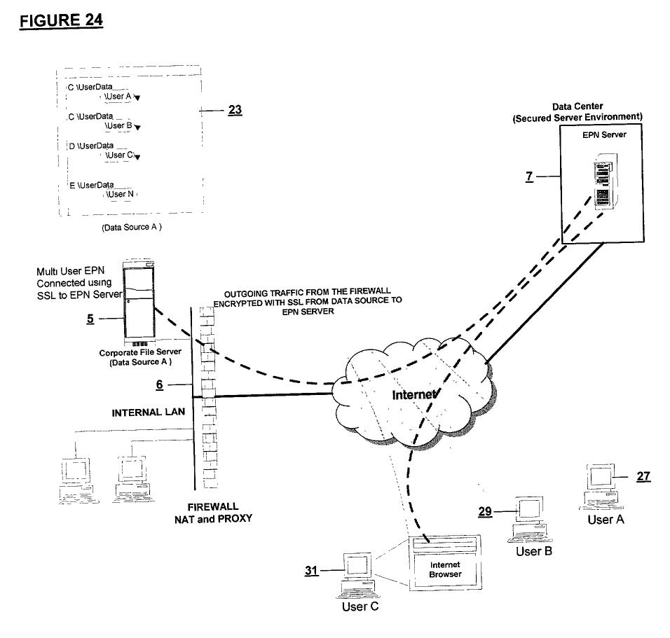

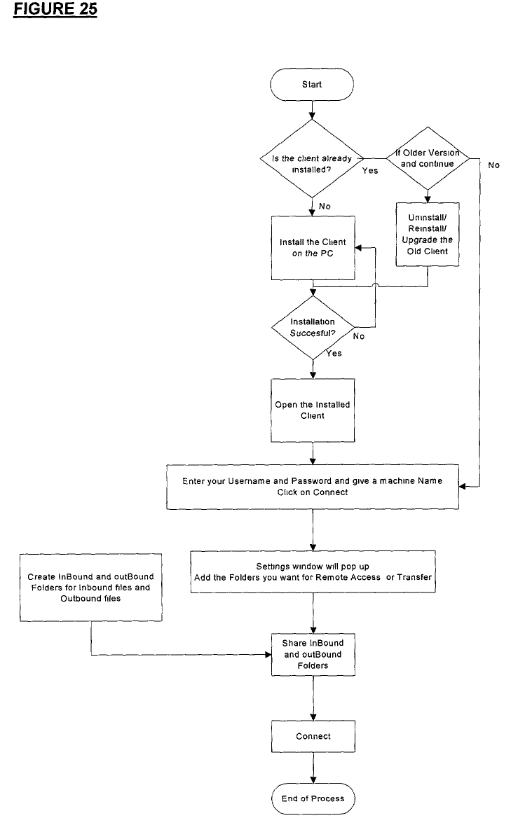

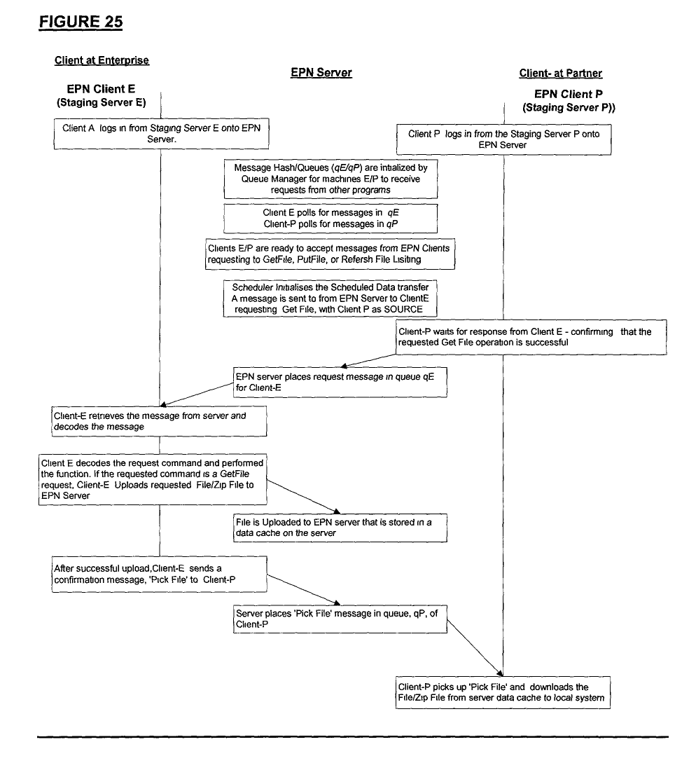

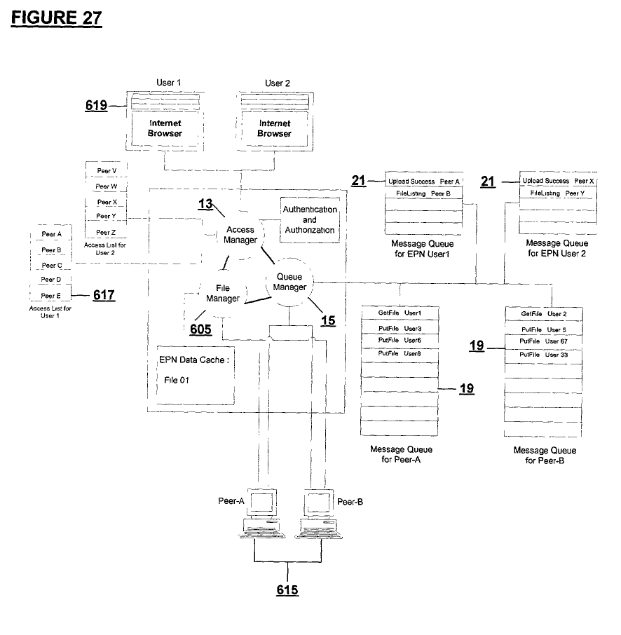

Within a business environment, a staging server is a data source, where data is organized and deposited for transfer to a partner's machine, which can be securely placed inside a corporate network and is thus protected by the corporate network's firewalls. By using EPN system technology the staging server data is available to partners without the risk of having the data reside outside the firewall. As shown in FIG. 24, EPN client software is installed on the staging server 201 (Staging Server E in FIG. 26) that is used for secure file transfer. FIG. 25 describes the installation of the staging server. FIG. 26 describes the sequence of steps for a complete operation of a scheduled transfer of data. FIG. 27 shows the message flow between EPN elements corresponding to the sequence of FIG. 26. As shown in the figures, after installation, the client registers with an EPN Server by providing unique credentials and is authenticated by the Access Manager part of the EPN Server. Once authenticated the client runs as an always available service (or daemon). A Queue Manager in the EPN Server software creates a unique queue for the staging server that holds request messages to be picked up by EPN client on the staging server. The EPN Client maintains a non-persistent connection through a polling algorithm and services requests waiting in the queue.

Instructions are sent to the Partner company to establish a staging server on their side—Staging Server P within their corporate network to be able to receive data from the enterprise.

This invention incorporates a granular security architecture allowing an administrator at the Enterprise to define access lists to allow the Partner to access only explicitly permissioned data. The allowed privileges are READ and WRITE-WITHOUT-OVERWRITE. The Partner cannot access any other data, delete files in the permissioned area or remotely run any programs (potential virus) on the Staging Server E. The Partner company's administrator also has the same level of control over access from the Enterprise.

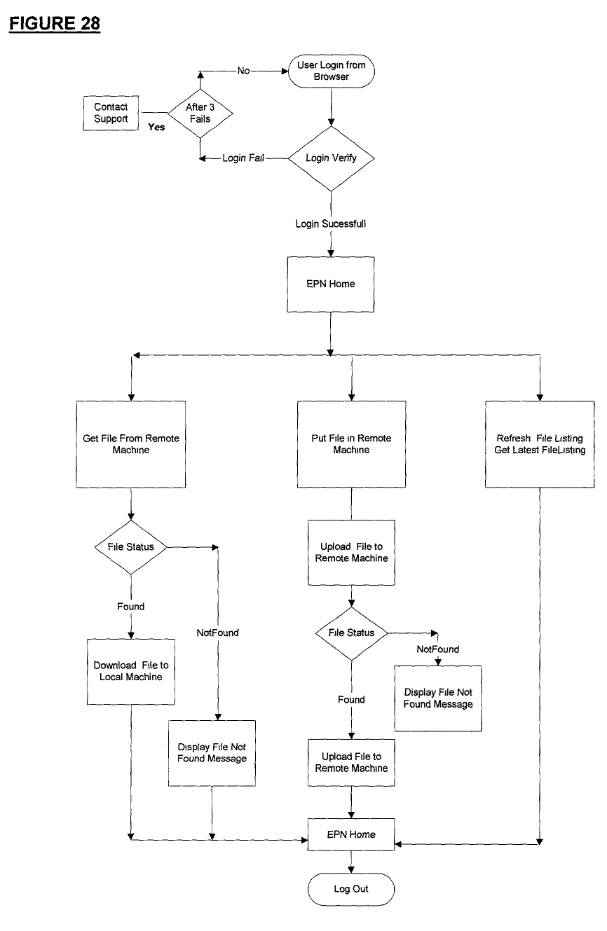

A schedule for transfer of data between two staging servers can be set up as shown in the steps depicted in FIG. 28. The administrator can access the EPN Server by providing the necessary credentials, such as userid and password, and can manage the remote user list and their access permissions. The administrator can identify data files or folders containing the relevant files, and set up schedules to transmit the data between the staging servers. The schedules are recorded on the EPN Server and at the scheduled time instructions are issued to the EPN client to transport the selected files/folders to the target staging server. Schedules can be set up to either ‘push’ a file to a remote server or ‘pull’ a file from the remote server. Since no files can be deleted or overwritten, the staging area is protected from unauthorized access.

When an administrator logs in to the EPN account from a browser, a Peer Neighborhood of allowed “remote staging servers” is displayed (similar to Microsoft Network Neighborhood). The difference being that the peers can span across different partners, customers, clients or remote offices—all connected over the Internet connection using EPN secure and managed peer-to-peer technology.

All data transmissions between the Staging Servers (traveling via EPN Server) use standard SSL libraries for encryption of the payload. This eliminates a big cumbersome step in current set up at enterprises, where the data files are encrypted explicitly before the transmission and decrypted at the receiving end. Since EPN encrypts the data all the way between the points of transmission, there is no explicit requirement for encryption. The EPN client uses efficient compression techniques to improve throughput of available network connections.

A unique machine authentication procedure is implemented by creating a machine signature that is a combination of staging server's hardware address, username and password, thus eliminating all possibilities of any masquerading device hacking the data between the staging servers. This method is better than any IP address based schemes as the machine signature is unique and constant to that particular system. The Partner's access to data files is determined based on its allotted userid, password, access permissions and other credentials such as machine signature.

Significant embodiment of the invention is that EPN does not require any changes to existing network configurations (firewall, NAT or proxy) at either the Enterprise or the partner company. This means—the well-thought-out and implemented corporate security policy is not compromised on day-to-day basis.

Another significant aspect of the invention is—the flexibility in locating the staging area/server. A staging server can be placed inside the corporate network, within any of the internal LANs, or at the DMZ—the only requirement is that it requires access to Internet. This aspect gives great flexibility in offering extranet access to key business data, responding to requests from the business groups in a timely manner. The EPN Server maintains user ids (can integrate with Enterprise user id scheme with the help of plug-in authentication modules), access lists and audit logs for EPN management. The management and monitoring functions are accessible to the administrator from any browser, over a secure connection, from any location within the corporate network or from outside.

The EPN system gives the administrator additional flexibility to be able to manage EPN Data Movement function from a wireless device such as Palm, Blackberry, Handspring or an IPaq. The same level of functionality that is available from a browser can be extended to the wireless device. The EPN administrative interface is extensible to voice devices as well.

EPN—Customization and Integration with Other Applications

The EPN system may provide ‘EPN Remote Access’, ‘EPN Wireless Remote Access’ and secure data movement. These components work with other business applications to bring forth ‘remote access’ or data movement functionality for real-time access to dynamically changing data on remote machines.

The EPN components have an interface API (Application Programming Interface) for user registration (add, delete or modify users), service provisioning (enable, modify or disable features and services), access management (to control access lists), file management (file transport) and usage tracking (obtain event or operation details).

ISVs (independent Software Vendors) and partners can pick up the EPN component and integrate it with other software packages. People of skill will recognize that useful areas can be: in the medical field, where a doctor can give controlled access to patient's records to the patient, the patient's other network physicians or the patient's insurance carrier by integrating EPN Remote Access with their internal applications. Insurance carriers also can provide remote access to most current documents to doctors or their subscribers. For attorneys, they can extend simple to manage remote access facilities to their clients. Thus clients will always have access to latest copies of case documents that would be in progress in the attorney's office. At the end of a case, the administrator can easily remove the remote access connection. Such a facility can be integrated into any type of application for attorneys. Customer Relationship Management (CRM) applications can integrate an instantly deployable remote access solution such as EPN Remote Access so that the representatives can have better access into their customer's desktops for better diagnosis and online help.

Windows Explorer-based EPN

EPN System developed plug-ins to Windows Explorer can be developed so that a user can access remote peers direct from a desktop in a format similar to the Microsoft Network Neighborhood GUI. The EPN Peer Neighborhood does not depend on any specific platform for connectivity and can extend beyond the boundaries of the corporate network.

Wireless Features

The Wireless Remote Access feature is depicted in FIG. 30. Wireless Remote Access extends EPN remote access solution to wireless devices. This product is an integrated function of Remote Access and Mail components of an EPN system, which allows a user to send email from a wireless device including attachments picked from user's peer machines. Documents are fetched from remote peers and sent as attachments using an EPN Mail facility (or it can work with a partner's or client's email facility as well).

In operation, the user runs a small footprint mobile edition of an EPN client on the wireless device that allows the user to log in to an EPN server over a wireless network. After successful login, the user can compose an email message, and look for documents on remote peers to be sent as attachments. The user sees a list of online peer machines in the Peer Neighborhood, similar to what is seen in a browser; selects a peer, browses through the file listing to find the required document and requests the document to be sent as an attachment.

The EPN server runs the request by the Access Manager, and places it in the request queue of a selected peer. The EPN client (single or multi-user) on the peer machine, polls the request queue looking for requests, finds the request message and services it in the same fashion as described previously for the EPN. The EPN client responds in a manner independent of where the request originates. The request is serviced by uploading the requested file to EPN server and placing it in data cache.

The user completes the email message and clicks on a Send button to send the email. The EPN server invokes EPN mail to send the email message along with the attachment file residing in the data cache. Once the email is sent successfully, the attachment is deleted from the cache.

Transport between the peer and the EPN server is supported by SSL-based communication for security and authenticity. None of remote peer or data details are transported over the less-secure wireless network.

These are the advantages in this implementation: core EPN remote access is easily integrated with a Mail solution to create a powerful remote access solution; documents or attachments are not transferred on a low-bandwidth wireless network, instead they are shipped over a secure SSL-based network to the EPN server; the operations of the EPN remote access are independent of the type of wireless device; EPN remote access is easily extensible to retrieve user's PIM information from a remote peer, from one and only copy of PIM database maintained by the user and displayed on the wireless device.

Voice Interface

A still further embodiment of the present invention involves a voice Interface. Here, Wireless Remote Access functionality can be easily extended to a telephone-based (wireless or wired) voice interface. The EPN System is integrated with a Voice Processing Server, that converts voice commands to standards-based machine readable data formats (such as VoiceXML). Once converted to machine-readable data, the message is handled similar to those that come from wireless PDAs. Based on the communication protocol, a set of easily-understood commands are developed for the

What is claimed is:

1. A distributed computing system for secure remote access by a user's access devices to secure data sources on one or more machines comprising
a limited virtual network established between peer machines, said peer machines comprising
a client software program (EPN client) that runs on a user's data source,
a server module that does not maintain a persistent connection with the EPN client, and
an access machine,
wherein the server module (EPN server) comprises
an access manager,
a queue manager, and
a file manager.

2. The distributed computing system of claim 1, further comprising a report manager to print detailed and summary reports on usage.

3. The distributed computing system of claim 1, wherein the access manager controls authentication, authorization and management of user communication.

4. The distributed computing system of claim 3, wherein the access manager helps set access lists for user peer machines with data, collects and maintains access lists with permissions in encrypted form on the EPN server, and screens incoming requests from data accessors.

5. The distributed computing system of claim 1, wherein the queue manager manages the creation of queues and secures operations on the queues.

6. The distributed computing system of claim 1, wherein the file manager manages transport of data/files between peers and the EPN Server.

7. The distributed computing system of claim 1, wherein said peer machines comprise
data sources to which the user has access and
the user's access devices.

8. The distributed computing system of claim 7, wherein a data source comprises a desktop or a server machine that stores user data.

9. The distributed computing system of claim 1, wherein
said server module comprises
a server that is accessible over the Internet; and
said access machine comprises
an Internet browser.

10. The distributed computing system of claim 7, wherein said data source, said server, and said browser are connected to the Internet.

11. The distributed computing system of claim 1, wherein
said server module comprises
a server that is accessible over the Internet; and
said access machine comprises
an extension of the Windows Explorer as a vehicle for requesting data transfers.

12. A method for a user to access remotely via an access machine data contained on a desktop computer comprising
registering online with a server module (EPN server),
obtaining from the EPN server an EPN client program,
installing the client program on the desktop computer, wherein said desktop computer becomes a data source.

13. The method for a user to access data remotely via an access machine of claim 12, wherein the step of registering comprises obtaining an id and password.

14. The method for a user to access data remotely via an access machine of claim 12, wherein the peer machine is on a network and the user has access to the network and
to bypass firewalls the user installs the client software on the computer and opens the installed client, completes a registration and adds folders to be accessed remotely.

15. A method for a user to access remotely via an access machine data contained on a desktop computer comprising
registering online with an EPN server,
obtaining from the EPN server an EPN client program,
installing the client program on the desktop computer, wherein said desktop computer becomes a data source,
starting the EPN client program on the user's data source.

16. The method for a user to access remotely via an access machine data contained on a desktop computer of claim 15, wherein the EPN client starts during system startup.

17. The method for a user to access remotely via an access machine data contained on a desktop computer of claim 15, wherein the EPN client programs connects to the EPN server over an HTTP tunnel.

18. The method for a user to access remotely via an access machine data contained on a desktop computer of claim 15, wherein the client uses a simple message protocol to communicate with the EPN server.

19. The method for a user to access remotely via an access machine data contained on a desktop computer of claim 18, wherein the protocol encodes application and user data packets using HTML format.

20. The method for a user to access remotely via an access machine data contained on a desktop computer of claim 19, wherein data packets are encrypted using secure socket layer libraries.

21. The method for a user to access remotely via an access machine data contained on a desktop computer of claim 18, wherein client to server communication is conducted entirely using HTTPS.

22. A method for a user to access remotely, via an access machine, data contained on a desktop computer comprising
registering online with an EPN server,
obtaining from the EPN server an EPN client program,
installing the client program on the desktop computer, wherein said desktop computer becomes a data source,
setting up access controls by the user or a corporate administrator to restrict access by the client to a limited set of data, said access controls comprising a master access list.

23. The method for a user to access remotely, via an access machine, data contained on a desktop computer of claim 22, wherein the master access list is set up using the EPN client on the user's peer (data source).

24. The method for a user to access remotely, via an access machine, data contained on a desktop computer of claim 23, wherein the access list is modified within a subset of the master access list by using browser-based access to the EPN server.

25. The method for a user to access remotely, via an access machine, data contained on a desktop computer of claim 24, wherein access permissions are set up at the directory or file level.

26. The method for a user to access remotely, via an access machine, data contained on a desktop computer of claim 25, wherein the access machine is denied access to any other part of the corporate network or any data beyond what is set in the access list.

27. The method for a user to access remotely, via an access machine, data contained on a desktop computer of claim 22, comprising
having the EPN server's Access Manager authenticate a peer based on the peer's login id and password,
creating request queues for the peer,
having the EPN client polling the EPN server for requests in its request queue.

28. The method for a user to access remotely, via an access machine, data contained on a desktop computer of claim 22, wherein the EPN Client does not maintain persistent connection with EPN Server comprising
opening a network connection with an EPN Server,
picking up any request messages in its request queue or posting messages in the queue of another EPN program and closing the connection.

29. The method for a user to access remotely, via an access machine, data contained on a desktop computer of claim 28, wherein the client communicates with the server at a frequency that is determined based on its stat.

30. The method for a user to access remotely, via an access machine, data contained on a desktop computer of claim 29, wherein the allowed states for an EPN client to be in are
an initial state (Sᵢₙᵢₜᵢₐₗ)]
an active state (S_{active}), and
an inactive state (S_{inactive}).

31. The method for a user to access remotely, via an access machine, data contained on a desktop computer of claim 30, wherein
in the initial state the client communicates with the EPN server at a frequency interval of Tᵢₙᵢₜᵢₐₗ seconds looking for any active messages,
if the EPN client does not find any message to service over Fₙ enquiries to the EPN Server, the frequency is increased to a maximum of T_{inactive} (maximum inactive interval) in steps of Tₛₜₑₚ.

32. The method for a user to access remotely, via an access machine, data contained on a desktop computer of claim 31, wherein T_{active}<Tᵢₙᵢₜᵢₐₗ<=T_{inactive}.

33. The method for a user to access remotely, via an access machine, data contained on a desktop computer of claim 28, wherein the EPN client programs running on a user's peer machines polls the EPN server at periodic intervals and closes the connection after each pole.

35. A method for a user with a browser accessing remotely, via an access machine having a browser, data contained on a computer in the peer neighborhood comprising
registering online with an EPN server,
obtaining from the EPN server an EPN client program,
installing the client program on the desktop computer, wherein said desktop computer becomes a data source,
authenticating the user as a peer,
creating a Reply (qB) queue on the EPN server,
selecting a peer machine from the list of peer machines available configured or interfaceable in the peer neighborhood
selecting one or more files to be downloaded to the remote machine from the listing of files that are configured previously on the peer for remote access.
communicating this request to the EPN server,
polling the EPN Server for a response in its reply queue,
having the EPN Server verify the request by looking into the access control list,
entering the request into the request queue for Peer A,
allows the EPN client polling from Peer A to pick up the requested data.

36. The method for a user with a browser accessing remotely, via an access machine having a browser, data contained on a computer in the peer neighborhood of claim 35, further comprising the client
finding and picking up the request message as the EPN client polls qA,
decoding the message to find that a file on the peer machine needs to be picked up and sent out,
uploading the file to the EPN Server over an encrypted channel,
storing the file in a data cache on the EPN Server for subsequent pick up,
sending a response to the EPN server so that the response is deposited in a reply queue for the user coming in from Peer B.

37. The method for a user with a browser accessing remotely, via an access machine having a browser, data contained on a computer in the peer neighborhood of claim 36, further comprising the browser program
finding the response message in its reply queue—qB,
finding the location of requested data file in EPN server's data cache,
downloading the file to the desktop (Peer B), and
upon successful completion the file is cleared from the cache.

38. A method for a user with a windows explorer accessing remotely, via an access machine having a windows explorer, data contained on a computer in the peer neighborhood comprising
registering online with an EPN server,
obtaining from the EPN server an EPN client program,
installing the client program on the desktop computer, wherein said desktop computer becomes a data source,
authenticating the user as a peer,
creating a Reply (qB) queue on the EPN server,
selecting a peer machine from the list of peer machines available configured or interfaceable in the peer neighborhood
selecting one or more files to be downloaded to the remote machine from the listing of files that are configured previously on the peer for remote access.
communicating this request to the EPN server,
polling the EPN Server for a response in its reply queue,
having the EPN Server verify the request by looking into the access control list,
entering the request into the request queue for Peer A,
allows the EPN client polling from Peer A to pick up the requested data.

39. A distributed computing system for secure remote access by a user's access devices to secure data sources on one or more machines comprising
a limited virtual network established between peer machines, said peer machines comprising
a client software program (EPN client) that runs on a user's data source,
a server module, and
an access machine,
wherein data accessor and data source are disconnected processes joined only by asynchronous communication using queues, and
wherein no changes are required in the corporate firewall or network configurations.

40. A method for using a distributed computing system for secure remote access by a plurality of user's access devices to secure data sources on one or more machines comprising a limited virtual network established between peer machines, said peer machines comprising a client software program (EPN client) that runs on a user's data source, a server module, and an access machine, said method comprising
downloading and installing the EPN client on a first peer machine (Peer A),
creating a message queue (qA) on the server module (EPN Server),
creating a master access list on Peer A for remote access,
saving the master list to a file and uploading it to the EPN Server,
having the EPN client poll for messages,
causing a second peer machine (Peer B) to log in to the EPN Server using a web browser,
creating a message queue (qB) for Peer B on the EPN Server,
causing Peer B to assign folders for remote access from a subset of the master list and saving the subset as an access list file on the EPN Server.

41. The method for using a distributed computing system for secure remote access of claim 40 further comprising
updating the master access list on Peer A and uploading the updated master list to the EPN server, and
updating the access list file on the EPN server.

42. A distributed computing system for secure remote access by a user's access devices to secure data sources on one or more machines comprising
a limited virtual network established between peer machines, said peer machines comprising
a client software program (EPN client) that runs on a user's data source,
a central manager server module that maintains request and reply queues to enable asynchronous communication so that no program awaits a response, and
an access machine.

43. An authentication procedure for providing security of a distributed computing system for secure remote access by a user's access devices to secure data sources on one or more machines said distributed computing system comprising
a limited virtual network established between peer machines, said peer machines comprising
a client software program (EPN client) that runs on a user's data source,
a server module, and
an access machine.
said authentication procedures comprising
setting up users in the EPN system using EPN's native authentication system.

44. A method for a user having a computer to access remotely, via an access machine, data contained on an EPN server, comprising
registering online with an EPN server,
obtaining from the EPN server an EPN client program, said EPN server not maintaining a persistent connection with the EPN client,
installing the client program on the computer,
retrieving the data by the user from the EPN server by use of a browser.
